(19) United States
(12) Patent Application Publication
(10) Pub. No.: US 2009/0303304 A1
(43) Pub. Date: Dec. 10, 2009

(54) RADIATION-CURABLE INK COMPOSITION, RECORDING METHOD, RECORDED MATTER, INK SET, INK CARTRIDGE FOR INK JET RECORDING, INK JET RECORDING APPARATUS, RADIATION DETECTION METHOD, AND MANAGEMENT METHOD

(75) Inventors: Takashi OYANAGI, Matsumoto-shi (JP); Chiyoshige Nakazawa, Suwa-shi (JP)

Correspondence Address: LADAS & PARRY, 26 West 61st Street, New York, NY, 10023, US

(73) Assignee: SEIKO EPSON CORPORATION

(21) Appl. No.: 12/473,784

(22) Filed: May 28, 2009

(30) Foreign Application Priority Data
Jun. 5, 2008 (JP) 2008-147703

(51) Int. Cl. B41J 2/01; C08F 2/46; B05D 5/00; B05D 1/36; C08J 7/18; B32B 3/10; G01N 21/00

(52) U.S. Cl. 347/100; 522/174; 427/256; 427/265; 427/487; 428/195.1; 250/474.1; 347/102

(57) ABSTRACT

A radiation-curable ink composition contains a dye; and a pigment having a color of a hue that is not adjacent to a hue of the color of the dye in ten hues of the Munsell color system.

### BACKGROUND

1. Technical Field

The present invention relates to a radiation-curable ink composition, a recording method, a recorded matter, an ink set, an ink cartridge for ink jet recording, an ink jet recording apparatus, a radiation detection method, and a management method.

2. Related Art

An ink jet recording method is a printing method in which droplets of an ink composition are made to travel toward and adhere to a recording medium, such as paper, to conduct printing. This recording method has a feature that an image having a high resolution and high quality can be printed at a high speed. Recently, radiation-curable inks that are cured by radiation such as ultraviolet rays have been developed. Such a radiation-curable ink can realize recording in which the ink is quickly dried and bleeding of the ink is prevented in a recording on non-absorbing media that do not absorb an ink, e.g., plastics. Such a radiation-curable ink contains a polymerizable compound, a polymerization initiator, a coloring component, and the like.

Polymerizable compounds are divided into radically polymerizable compounds and cationically polymerizable compounds in accordance with the composition thereof, the polymerization method thereof, and the like. Among these, radically polymerizable compounds have been actively developed because a radical polymerization initiator and other additional components can be relatively easily incorporated. When such a polymerizable compound contained in a radiation-curable ink polymerizes to produce a polymer, for example, abrasion resistance and adhesiveness (detachment resistance) of a printed image can be improved.

Typical examples of the coloring component include pigments and dyes of various colors. In general, pigments have good storage stability (light resistance, moisture resistance, weather resistance, oxidizing gas resistance, and the like) but have a poor color-forming property and transparency. In general, dyes are excellent in terms of the color-forming property and transparency but have poor storage stability. In view of these properties, in order to balance the weather resistance, the color-forming property, and dispersibility, an ink containing both a pigment and a dye having a color similar to the color of the pigment has been proposed (for example, JP-A-2004-339489). According to this technique, an ink composition of magenta may contain dyes and pigments of magenta, red, orange, and the like in combination.

However, in such an ink composition containing both a pigment and a dye, the color of the dye may be significantly degraded by being irradiated with radiation or by reacting with radicals generated by radiation. Thus, when a pigment and a dye are incorporated in an ink composition, a color development of the dye is changed by a chemical reaction for curing, and thus a desired color cannot be obtained. However, the inventors of the invention focused on an active use of the phenomenon in which a color of a dye is changed by radiation or the like and conducted intensive studies. As a result, the invention has been made.

### SUMMARY

An advantage of some aspects of the invention is to provide a radiation-curable ink composition, an ink set, an ink cartridge for ink jet recording, and an ink jet recording apparatus in which the amount of received radiation can be easily grasped.

Another advantage of some aspects of the invention is to provide a recorded matter in which the amount of received radiation can be easily grasped, and a recording method for forming the recorded matter.

Another advantage of some aspects of the invention is to provide a radiation detection method and method of managing an object using a radiation-curable ink composition or recorded matter in which the amount of received radiation can be easily grasped.

A radiation-curable ink composition according to an embodiment of the invention contains a dye, and a pigment having a color of a hue that is not adjacent to a hue of the color of the dye in ten hues of the Munsell color system.

According to this radiation-curable ink composition, the amount of received radiation can be easily grasped.

In the radiation-curable ink composition, the color of the pigment and the color of the dye may satisfy a complementary color relationship.

The radiation-curable ink composition may further contain a polymerizable compound.

In the radiation-curable ink composition, the polymerizable compound may have an unsaturated double bond.

In the radiation-curable ink composition, the polymerizable compound may have an active hydrogen-containing functional group.

In the radiation-curable ink composition, the active hydrogen-containing functional group may be an amino group, an imino group, or an alcoholic hydroxyl group.

The radiation-curable ink composition may further contain a radiation-sensitive radical polymerization initiator.

An ink set according to an embodiment of the invention includes the above radiation-curable ink composition.

In a recording method according to an embodiment of the invention, information is recorded using the above radiation-curable ink composition.

This recording method can provide a recorded matter in which the amount of received radiation can be easily grasped.

A recording method according to an embodiment of the invention is a method of recording information on a recording medium using an ink jet recording apparatus, the method including ejecting droplets of the above radiation-curable ink composition to cause the droplets of the radiation-curable ink composition to adhere to the recording medium.

A recording method according to another embodiment of the invention is a method of recording information on a recording medium using an ink jet recording apparatus, the method including mixing a first composition containing a dye with a second composition containing a pigment in the ink jet recording apparatus to prepare the above radiation-curable ink composition; and ejecting droplets of the radiation-curable ink composition to cause the droplets of the radiation-curable ink composition to adhere to the recording medium.

A recording method according to another embodiment of the invention is a method of recording information on a recording medium using an ink jet recording apparatus, the method including ejecting droplets of a first composition containing a dye to cause the droplets of the first composition to adhere to the recording medium; ejecting droplets of a second composition containing a pigment to cause the droplets of the second composition to adhere to the recording medium; and mixing the first composition with the second composition on the recording medium to prepare the above radiation-curable ink composition.

In this case, the droplets of the second composition may be caused to adhere to the recording medium first, and the droplets of the first composition may then be caused to adhere to the recording medium.

The recording method according to an embodiment of the invention may further include irradiating the droplets adhered to the recording medium with radiation.

A recorded matter according to an embodiment of the invention is recorded by the method described above. According to this recorded matter, the amount of received radiation can be easily grasped.

An ink set according to an embodiment of the invention includes the first composition and the second composition described above.

An ink cartridge for ink jet recording according to an embodiment of the invention includes the above ink set.

An ink jet recording apparatus according to an embodiment of the invention includes the above ink cartridge for ink jet recording.

The ink jet recording apparatus may further include an ultraviolet irradiation device.

A radiation detection method according to an embodiment of the invention includes detecting the amount of radiation exposure using the above recorded matter by a change in the color of the radiation-curable ink composition described above.

A radiation detection method according to another embodiment of the invention includes detecting the amount of radiation exposure using the radiation-curable ink composition described above by a change in the color of the radiation-curable ink composition.

A management method according to an embodiment of the invention is a method of managing an object using the above radiation detection method, the method including attaching the above recorded matter to the object; and measuring the amount of radiation or history of radiation irradiated onto the object by a change in the color of the recorded matter to manage the change in the object with time.

A management method according to another embodiment of the invention is a method of managing an object using the above radiation detection method, the method including attaching the above radiation-curable ink composition to the object; and measuring the amount of radiation or history of radiation irradiated onto the object by a change in the color of the radiation-curable ink composition to manage the change in the object with time.

According to this method, in attaching the radiation-curable ink composition, a container containing the radiation-curable ink composition may be attached to the object.

### DESCRIPTION OF EXEMPLARY EMBODIMENTS

Embodiment of the invention will now be described in detail.

### 1. Radiation-Curable Ink Composition

A radiation-curable ink composition according to the invention contains a dye and a pigment.

### 1.1. Dye

Examples of the dye contained in the radiation-curable ink composition include direct dyes, acid dyes, food dyes, basic dyes, reactive dyes, disperse dyes, vat dyes, soluble vat dyes, water-soluble dyes, and oil-soluble dyes.

The dye contained in the radiation-curable ink composition has a color that can be classified into any of ten hues of the Munsell color system (which will be described in detail below). Specifically, the dye has a chromatic color.

The color of a dye contained in the radiation-curable ink composition is changed or degraded (removed) when the dye absorbs radiation (such as visible rays, ultraviolet rays, X rays, or particle beams) to undergo a chemical change and/or the dye comes into contact with radicals to undergo a chemical reaction. That is, when a dye is irradiated with radiation, the color of the dye is changed or degraded by a direct or indirect action. Herein, the terms “direct action” and “indirect action” mean the following: When a dye is affected by irradiation itself, the action is referred to as “direct action”. When radicals are generated in a radiation-curable ink composition by radiation and a dye is affected by reacting with the radicals, the action is referred to as “indirect action”. In dyes, a color change or discoloration is significantly caused by the indirect action rather than by the direct action. The term “radicals” refers to radicals that are generated in a radiation-curable ink composition and includes radicals generated when a radiation-sensitive radical polymerization initiator or the like is decomposed by absorbing radiation and radicals generated when a component constituting a radiation-curable ink composition is chemically changed by absorbing radiation. The degree of color change or discoloration may change in accordance with the amount of irradiation of radiation, the amount of integrated irradiation (irradiation history), the amount of generated radicals, or the amount of radicals that have been integrally generated (generation history of radicals).

Among the dyes exemplified above, oil-soluble dyes can be particularly preferably used in the radiation-curable ink composition of the invention. The term “oil-soluble dyes” refers to dyes that are satisfactorily soluble in a liquid compound other than water under an environment of normal temperature and normal pressure and that are substantially insoluble in water. Oil-soluble dyes having a solubility in water at 25° C. (the weight of a dye that is soluble in 100 g of water) of 1 g or less can be used. The molecules of such an oil-soluble dye are dissolved in the radiation-curable ink composition in the form of a single molecule, or dissolved in the radiation-curable ink composition to form an extremely small aggregate (having a diameter of about several tens of nanometers) in which several molecules gather together.

Specific examples of the oil-soluble dye are described below. In the description of specific examples below, the oil-soluble dyes are broadly classified into blue dyes, red dyes, and yellow dyes. Medium color dyes, namely, green dyes and violet dyes will also be described in the groups of the above classification. When a color exhibited by an oil-soluble dye is located between two adjacent hues among the ten hues of the Munsell color system, the color exhibited by the oil-soluble dye is assumed to belong to a hue located in the clockwise direction of a hue circle (which will be described below) of the Munsell color system from the color.

Examples of the blue oil-soluble dyes include indoaniline dyes; indophenol dyes; azomethine dyes containing a pyrrolotriazole derivative as a coupling component; polymethine dyes such as cyanine dyes, oxonol dyes, and merocyanine dyes; carbonium dyes such as diphenylmethane dyes, triphenylmethane dyes, and xanthene dyes; phthalocyanine dyes; anthraquinone dyes; aryl dyes and heterylazo dyes, all of which contain a phenol derivative, a naphthol derivative, or an aniline derivative as a coupling component; and indigo/thioindigo dyes.

Specific examples of the blue oil-soluble dyes include Macrolex Blue RR and FR (manufactured by Bayer), Sumiplast Green G (manufactured by Sumitomo Chemical Co., Ltd.), Vali Fast Blue 2606, Oil Blue BOS (manufactured by Orient Chemical Industries Ltd.), Aizen Spilon Blue GNH (manufactured by Hodogaya Chemical Co., Ltd.), Neopen Blue 808, Neopen Blue FF4012, Neopen Cyan FF4238 (manufactured by BASF Ltd.), Oil Violet #730 (manufactured by Orient Chemical Industries Ltd.), C.I. Solvent Blue-2, -11, -25, -35, -38, -43, -67, -70, and -134, C.I. Solvent Green-1, -3, -7, -20, and -33, and C.I. Solvent Violet-2, -3, -11, and -47.

Examples of the red oil-soluble dyes include aryl dyes and heterylazo dyes, all of which contain a phenol derivative, a naphthol derivative, or an aniline derivative as a coupling component; azomethine dyes containing a pyrazolone derivative or a pyrazolotriazole derivative as a coupling component; methine dyes such as arylidene dyes, styryl dyes, merocyanine dyes, and oxonol dyes; carbonium dyes such as diphenylmethane dyes, triphenylmethane dyes, and xanthene dyes; quinone dyes such as naphthoquinone, anthraquinone, and anthrapyridone; and fused polycyclic dyes such as dioxazine dyes.

Specific examples of the red oil-soluble dyes include Oil Red 5303 (manufactured by Arimoto Chemical Co., Ltd.), Oil Red SB, Oil Pink 312, Oil Scarlet 308 (manufactured by Orient Chemical Industries Ltd.), Oil Red XO (manufactured by Kanto Chemical Co., Ltd.), Neopen Mazenta SE1378 (manufactured by BASF Ltd.), Oil Brown GR (manufactured by Orient Chemical Industries Ltd.); C.I. Solvent Red-1, -3, -8, -18, -24, -27, -43, -49, -51, -72, -73, -109, -111, -229, -122, -132, and -219; C.I. Solvent Brown-1, -12, and -58; and ORASET RED BG (manufactured by Ciba Specialty Chemicals Inc.).

Examples of the yellow oil-soluble dyes include aryl dyes and heterylazo dyes, all of which contain a phenol derivative, a naphthol derivative, an aniline derivative, a pyrazolone derivative, a pyridone derivative, or an open-chain active methylene compound as a coupling component. Examples thereof further include methine dyes such as azomethine dyes, benzylidene dyes, and monomethine oxonol dyes, and quinone dyes such as naphthoquinone dyes and anthraquinone dyes, all of which contain an open-chain active methylene compound as a coupling agent. Furthermore, examples of yellow dyes other than the above dyes include quinophthalone dyes, nitro/nitroso dyes, acridine dyes, and acridinone dyes.

Specific examples of the yellow oil-soluble dyes include Oil Yellow 3G, Oil Yellow 129, Oil Yellow 105 (manufactured by Orient Chemical Industries Ltd.), Fast Orange G, Neopen Yellow 075 (manufactured by BASF Ltd.), ORASET YELLOW 3GN (manufactured by Ciba Specialty Chemicals Inc.), C.I. Solvent Yellow-1, -14, -16, -19, -25:1, -29, -30, -56, -82, -93, -162, and -172; and C.I. Solvent Orange-1, -2, -40:1, and -99.

In the radiation-curable ink composition, in addition to the oil-soluble dyes mentioned above, other dyes such as water-soluble dyes can also be suitably used as dyes as long as the dyes have a property that the color thereof is changed by radiation.

Two or more types of the above dye may be incorporated in combinations in the radiation-curable ink composition. When a plurality of dyes are used in combination, combinations that form an achromatic color are also included. Even in such a case, the color of the radiation-curable ink composition can be changed by a color change or discoloration of the dyes. Accordingly, no problems occur in terms of knowing the amount of irradiated radiation and the amount of generated radicals.

The radiation-curable ink composition may further contain a black dye in order to, for example, adjust the value of the color of the above dyes. As in the above-described chromatic color dyes, the color of a black dye is degraded or changed when the black dye is irradiated with radiation (such as visible rays, ultraviolet rays, X rays, or particle beams) and/or the black dye reacts with radicals. Specific examples of the black dye include Sudan Black X60 (manufactured by BASF Ltd.), Nubian Black PC-0850, Oil Black HBB (manufactured by Orient Chemical Industries Ltd.); and C.I. Solvent Black-3, -7, -22:1, -27, -29, -34, and -50.

The content of the dye contained in the radiation-curable ink composition is preferably in the range of 0.1 to 25 mass percent, and more preferably in the range of 0.5 to 15 mass percent.

### 1.2. Pigment

The pigment used in the radiation-curable ink composition has a color of a hue that is not adjacent to a hue of the color of the above-described dye in the ten hues of the Munsell color system. The pigment has a color that can be classified into any of the ten hues of the Munsell color system (which will be described in detail below). That is, the pigment has a chromatic color. When a color exhibited by the pigment is located between two adjacent hues among the ten hues of the Munsell color system, the color exhibited by the pigment is assumed to belong to the hue located in the clockwise direction of a hue circle (which will be described below) of the Munsell color system from the color.

As compared with the colors of the dyes described above, the colors of pigments are not readily changed or degraded (removed) when the pigments are irradiated with radiation (such as visible rays, ultraviolet rays, X rays, or particle beams) or the pigments react with radicals.

The pigment is not particularly limited as long as the pigment has a chromatic color. Examples of the pigment include organic pigments and inorganic pigments. Examples of the organic pigment include azo pigments (including azo lakes, insoluble azo pigments, condensed azo pigments, chelate azo pigments, and the like); polycyclic pigments (such as phthalocyanine pigments, perylene pigments, perynone pigments, anthraquinone pigments, and quinofuralone pigments), dye chelates (such as basic dye-type chelates and acidic dye-type chelates), nitro pigments, nitroso pigments, and aniline black. Specific examples of the pigment used in the radiation-curable ink composition will be described below.

Examples of yellow pigments include C.I. Pigment Yellow 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213.

Examples of red pigments include C.I. Pigment Red 5, 7, 12, 48 (Ca), 48 (Mn), 57 (Ca), 57:1, 112, 122, 123, 168, 184, 202, and 209; and C.I. Pigment Violet 19.

Examples of blue pigments include C.I. Pigment blue 1, 2, 3, 15:3, 15:4, 60, 16, and 22.

The radiation-curable ink composition may contain a mixture of a plurality of pigments. When a plurality of pigments are contained, as a result of a color mixture of the pigments, combinations that form an achromatic color are included. In the case where the pigments have an achromatic color, when a color change due to a color change or discoloration of a dye occurs in the radiation-curable ink composition, it becomes difficult to detect the color change in the radiation-curable ink composition. Therefore, combinations of pigments having an achromatic color are not preferable. Accordingly, when a plurality of pigments are mixed, the pigments are preferably selected such that the resulting color mixture of the pigments has a chromatic color.

The average particle diameter of the pigment is preferably in the range of 10 to 200 nm, and more preferably in the range of 50 to 150 nm.

The amount of pigment added to the radiation-curable ink composition is preferably in the range of 0.1 to 25 mass percent, and more preferably in the range of 0.5 to 15 mass percent.

The radiation-curable ink composition may contain a dispersant or a surfactant in order to satisfactorily disperse these pigments. Dispersants that are usually used for preparing a pigment dispersion liquid, for example, polymer dispersants, can be preferably used. Specific examples of the polymer dispersants include polyoxyalkylene polyalkylene polyamines. Specific examples of the polyoxyalkylene polyalkylene polyamines include Discole N-503, N-506, N-509, N-512, N-515, N-518, and N-520 (manufactured by Dai-Ichi Kogyo Seiyaku Co., Ltd.).

In order to, for example, adjust the value of the color of the above pigments, the radiation-curable ink composition may contain a pigment not having a chroma, such as a black pigment, a white pigment, or a pigment having another particular color. As in the above-described pigments having a chromatic color, discoloration or a color change does not readily occur in a black pigment when the black pigment is irradiated with radiation (such as visible rays, ultraviolet rays, X rays, or particle beams) or reacts with radicals. Examples of such a pigment include inorganic pigments such as titanium oxide and iron oxide, and carbon black produced by a known method such as a contact method, a furnace method, or a thermal method.

Specific examples of the black pigment that can be used in this embodiment include C.I. Pigment Black 7 as carbon black. Specific examples thereof further include No. 2300, No. 900, MCF88, No. 33, No. 40, No. 45, No. 52, MA7, MA8, MA100 and No. 2200B available from Mitsubishi Chemical Corporation; Raven 5750, 5250, 5000, 3500, 1255, and 700 available from Columbia Chemical Corporation, Regal 400R, 330R, and 660R, Mogul L, Mogul 700, Monarch 800, 880, 900, 1000, 1100, 1300, and 1400 available from Cabot Corporation; and Color Black FW1, FW2, FW2V, FW18, and FW200, Color Black S150, S160, and S170, Printex 35, U, V, and 140U, and Special Black 6, 5, 4A, and 4 available from by Degussa AG.

Examples of the white pigment that can be used in this embodiment include titanium dioxide, calcium carbonate calcium sulfate, zinc oxide, barium sulfate, barium carbonate, silica, alumina, kaolin, clay, talc, white earth, aluminum hydroxide, magnesium carbonate, and a white hollow resin emulsion. Preferably, one or a mixture of two or more types of pigments selected from the group consisting of these pigments is used.

Examples of the particular color pigment that can be used in this embodiment include, but are not particularly limited to, pigments for a metallic ink that can impart metallic gloss. Examples of such a metallic pigment include metallic pigments produced by sequentially laminating, on a sheet-like substrate, a resin layer for detachment and a metal layer or a metallic compound layer in that order to prepare a composite pigment base material, detaching the composite pigment base material from the sheet-like substrate at the interface between the metal layer or the metallic compound layer and the resin layer for detachment, and crushing the detached composite pigment base material. The metal or the metallic compound used in the metal layer or the metallic compound layer of the composite pigment base material is not particularly limited as long as the metal or the metallic compound has functions of having metallic gloss and the like. Examples thereof include aluminum, silver, gold, nickel, chromium, tin, zinc, indium, titanium, and copper. At least one of these metal elements, alloys thereof, and mixtures thereof can be used.

The pigments used in the radiation-curable ink composition may be used as a mixture in order to adjust the color tone of the pigments. For example, in order to change the color tone of a reddish black to a bluish black, Pigment Black 7 and Pigment Blue 15:3 may be used as a mixture. Furthermore, as a pigment, a fluorescent whitening agent may be added to the radiation-curable ink composition.

### 1.3. Relationship Between Hue of Dye and Hue of Pigment

When the radiation-curable ink composition is irradiated with radiation, the color of the above-described dye changes or degrades whereas the color of the above-described pigment barely changes. In addition to this, a hue to which the color of the dye belongs and a hue to which the color of the pigment belongs are not adjacent to each other in ten hues of the Munsell color system. Accordingly, the radiation-curable ink composition can significantly exhibit a “color change” when irradiated with radiation.

Thus, the color of the radiation-curable ink composition changes in accordance with at least one of the amount of irradiated radiation and the amount of radicals generated in the radiation-curable ink composition. Accordingly, the amount of irradiated radiation and the amount of radicals generated in the radiation-curable ink composition can be easily known. Herein, the term “color change in the radiation-curable ink composition” refers to at least one change in the hue, the value, and the chroma.

The Munsell color system is a system that numerically specifies colors on the basis of three attributes of colors (hue, value, and chroma). An example of a method of specifying colors using the Munsell color system is a “Method of specifying color: Specification based on three attributes” described in Japanese Industrial Standards (JIS) Z8721. The hues of the Munsell color system used in this specification include ten hues including five hues composed of red (R), yellow (Y), green (G), blue (B), and purple (P); and five hues of medium colors of these, namely, yellow red (YR), green yellow (GY), blue green (BG), purple blue (PB), and red purple (RP). In addition, the relationship between the ten hues in the Munsell color system refers to the relationship in a hue circle of the Munsell color system in which these ten hues are arranged in a circle at regular intervals in the order of red (R), yellow red (YR), yellow (Y), green yellow (GY), green (G), blue green (BG), blue (B), purple blue (PB), purple (P), and red purple (RP). Accordingly, the phrase “not adjacent in the ten hues of the Munsell color system” means the relationship in which colors are not adjacent to each other in this hue circle of the Munsell color system. Note that other Munsell color systems in which the hues are more finely divided are also present, but the above-described Munsell color system in which the hues are divided into the ten hues is used in this specification. Furthermore, in this specification, when the relationship between the ten hues of the Munsell color system is specified, the value and the chroma can be arbitrary.

In the radiation-curable ink composition, a hue of the color of a dye and a hue of the color of a pigment are not adjacent to each other in the ten hues of the Munsell color system. That is, a difference between the hue of the color of the dye and the hue of the color of the pigment is large. Consequently, when the color of the dye is changed or degraded in the radiation-curable ink composition, the color of the pigment is more significantly expressed. Thereby, it becomes easy to detect the amount of radiation received by the radiation-curable ink composition and the amount of radicals generated in the radiation-curable ink composition.

In the radiation-curable ink composition, the color of the pigment can be selected such that the color of the pigment and the color of the dye satisfy a complementary color relationship. The term “complementary color relationship” used herein refers to a relationship of physically complementary colors or a relationship of psychologically complementary colors. That is, the term “complementary color relationship” refers to a relationship between hues located opposite to each other in a hue circle of various color systems, which are not limited to the Munsell color system. Whether the complementary color relationship is the relationship of physically complementary colors or the relationship of psychologically complementary colors depends on the type of color system. In the case where two colors satisfy the relationship of physically complementary colors, an achromatic color is formed by additive mixing of these two colors. On the other hand, in the case where two colors satisfy the relationship of psychologically complementary colors, the two colors satisfy the following relationship: One color is viewed on a white background, and only the white background is subsequently viewed. In this case, a color perceived from the residual image is the other color.

In the radiation-curable ink composition, when the color of the pigment is selected such that the color of the pigment and the color of the dye satisfy a complementary color relationship, the difference between the hue of the color of the dye and the hue of the color of the pigment is further increased. Therefore, when the color of the dye is changed or degraded in the radiation-curable ink composition, the color of the pigment is more significantly expressed. Thereby, it becomes easier to detect the amount of radiation received by the radiation-curable ink composition and the amount of radicals generated in the radiation-curable ink composition.

As described in the sections of dye and pigment, the radiation-curable ink composition may contain a plurality of dyes and a plurality of pigments. When the radiation-curable ink composition contains a single pigment and a plurality of dyes, it is sufficient that the dyes or the pigment is selected such that the hue to which the color of at least one of the dyes belongs and the hue to which the color of the pigment belongs are not adjacent to each other in the ten hues of the Munsell color system. On the other hand, when the radiation-curable ink composition contains a single dye and a plurality of pigments, the dye or the pigments are preferably selected such that each of the hues to which the colors of all the pigments belong and the hue to which the color of the dye belongs are not adjacent to each other in the ten hues of the Munsell color system. The reason for this is to avoid a phenomenon in which a color change or discoloration of the dye is not readily detected due to the colors of the pigments. Similarly, when the radiation-curable ink composition contains a plurality of dyes and a plurality of pigments, the dyes or the pigments are preferably selected such that each of the hues to which the colors of all the pigments belong and the hue to which the color of at least one of the dyes belongs are not adjacent to each other in the ten hues of the Munsell color system.

When the radiation-curable ink composition contains a single pigment and a plurality of dyes and the color of the pigment is selected such that the color of the pigment and the color of a dye satisfy a complementary color relationship, it is sufficient that the dyes and the pigment are selected such that the color of at least one of the dyes and the color of the pigment satisfy a complementary color relationship. On the other hand, when the radiation-curable ink composition contains a single dye and a plurality of pigments and the color of a pigment is selected such that the color of the pigment and the color of the dye satisfy a complementary color relationship, the dye and the pigments are preferably selected such that the color of at least one of the pigments and the color of the dye satisfy a complementary color relationship and each of the colors of the other pigments is not adjacent to the color of the dye. The reason for this is to avoid a phenomenon in which a color change or discoloration of the dye is not readily detected due to the colors of the pigments. Similarly, when the radiation-curable ink composition contains a plurality of dyes and a plurality of pigment and the color of a pigment is selected such that the color of the pigment and the color of a dye satisfy a complementary color relationship, the dyes and the pigments are preferably selected such that the color of at least one of the pigments and the color of at least one of the dyes satisfy a complementary color relationship and each of the colors of the other pigments is not adjacent to the color of the at least one of the dyes.

### 1.4. Radiation

When the radiation-curable ink composition is irradiated with visible rays, ultraviolet rays in the range of 400 to 200 nm, far-ultraviolet rays, g-line, h-line, i-line, a KrF excimer laser beam, an ArF excimer laser beam, an electron beam, X-rays, a molecular beam, an ion beam, or the like as radiation, the color of a dye is changed or degraded by a direct or indirect action, and the overall color can be significantly changed. Examples of the radiation include not only radiations that are artificially generated but also sunlight and radiations that are present in nature (natural radiations). Accordingly, for example, the amount of radiation received during storage of the radiation-curable ink composition can also be easily grasped by a change in the color of the radiation-curable ink composition.

### 1.5. Polymerizable Compound

The radiation-curable ink composition may contain at least one type of polymerizable compound selected from known radically polymerizable compounds, allyl compounds, and N-vinyl compounds.

Examples of the radically polymerizable compounds include (meth)acrylates, (meth)acrylamides, and aromatic vinyls. In this specification, both of or one of “acrylate” and “methacrylate” may be described as “(meth)acrylate”, and both of or one of “acryl” and “methacryl” may be described as “(meth)acryl”.

Examples of monofunctional (meth)acrylates that can be used in the radiation-curable ink composition include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethylhexyl diglycol (meth)acrylate, butoxyethyl (meth)acrylate, 2-chloroethyl (meth)acrylate, 4-bromobutyl (meth)acrylate, cyanoethyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate; hydroxyalkyl (meth)acrylates such as 2-hydroxyethyl (meth)acrylate, 3-hydroxypropyl (meth)acrylate, 2-hydroxypropyl (meth)acrylate, 2-hydroxybutyl (meth)acrylate, and 4-hydroxybutyl (meth)acrylate; dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethyl succinic acid, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, EO-modified phenol (meth)acrylate, EO-modified cresol (meth)acrylate, EO-modified nonylphenol (meth)acrylate, PO-modified nonylphenol (meth)acrylate, and EO-modified-2-ethylhexyl (meth)acrylate.

Examples of bifunctional (meth)acrylates that can be used in the radiation-curable ink composition include 1,6-hexanediol di(meth)acrylate, 1,10-decanediol di(meth)acrylate, neopentyl glycol di(meth)acrylate, tripropylene glycol di(meth)acrylate, 2,4-dimethyl-1,5-pentanediol di(meth)acrylate, butyl ethyl propanediol di(meth)acrylate, ethoxylated cyclohexane methanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, hydroxypivalic acid neopentyl glycol di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butyl-propanediol di(meth)acrylate, 1,9-nonanediol di(meth)acrylate, propoxylated ethoxylated bisphenol A di(meth)acrylate, and tricyclodecane di(meth)acrylate.

Examples of trifunctional (meth)acrylates that can be used in the radiation-curable ink composition include trimethylolpropane tri(meth)acrylate, trimethylolethane tri(meth)acrylate, alkylene oxide-modified tri(meth)acrylates of trimethylolpropane, pentaerythritol tri(meth)acrylate, dipentaerythritol tri(meth)acrylate, trimethylolpropane tri((meth)acryloyloxypropyl)ether, isocyanuric acid alkylene oxide-modified tri(meth)acrylates, propionic acid dipentaerythritol tri(meth)acrylate, tri((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate, and ethoxylated glycerin tri(meth)acrylate.

Examples of tetrafunctional (meth)acrylates that can be used in the radiation-curable ink composition include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Examples of pentafunctional (meth)acrylates that can be used in the radiation-curable ink composition include sorbitol penta(meth)acrylate and dipentaerythritol penta(meth)acrylate.

Examples of hexafunctional (meth)acrylates that can be used in the radiation-curable ink composition include dipentaerythritol hexa(methacrylate), sorbitol hexa(methacrylate), alkylene oxide-modified hexa(methacrylate) of phosphazene, and caprolactone-modified dipentaerythritol hexa(meth)acrylate.

Examples of the (meth)acrylamides used that can be used in the radiation-curable ink composition include (meth)acrylamide, N-methyl (meth)acrylamide, N-ethyl (meth)acrylamide, N-propyl (meth)acrylamide, N-n-butyl (meth)acrylamide, N-tert-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, and (meth)acryloyl morpholine. Furthermore, in the radiation-curable ink composition, the above-mentioned (meth)acrylates, monofunctional or bifunctional (meth)acrylates, and (meth)acrylamides may be used in combination.

Specific examples of the aromatic vinyls that can be used in the radiation-curable ink composition include styrene, methylstyrene, trimethylstyrene, ethylstyrene, isopropylstyrene, chloromethylstyrene, methoxystyrene, acetoxystyrene, chlorostyrene, dichlorostyrene, bromostyrene, vinylbenzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-tert-butoxycarbonylstyrene, 4-methoxystyrene, and 4-tert-butoxystyrene.

Furthermore, examples of the radically polymerizable compound that can be used in the radiation-curable ink composition include vinyl esters (such as vinyl acetate, vinyl propionate, and vinyl versatate), allyl esters (such as allyl acetate), halogen-containing monomers (such as vinylidene chloride and vinyl chloride), vinyl ethers (such as methyl vinyl ether, butyl vinyl ether, hexyl vinyl ether, methoxy vinyl ether, 2-ethylhexyl vinyl ether, methoxyethyl vinyl ether, cyclohexyl vinyl ether, and chloroethylvinyl ether), vinyl cyanide (such as (meth)acrylonitrile), and olefins (such as ethylene and propylene).

The allyl compounds that can be used in the radiation-curable ink composition are compounds having a 2-propenyl structure (—CH₂CH═CH₂). The 2-propenyl group is also called an allyl group, and is a common expression in the IUPAC nomenclature system. The allyl compounds have radical polymerizability.

Specific examples of the allyl compound that can be used in the radiation-curable ink composition include ethylene glycol monoallyl ether, allyl glycol (all of which are available from, for example, Nippon Nyukazai Co., Ltd.); trimethylolpropane diallyl ether, pentaerythritol triallyl ether, and glycerin monoallyl ether (available from, for example, Daiso Co., Ltd.); and allyl group-containing polyoxyalkylene compounds having trade names of UNIOX, UNILUB, POLYCERIN and UNISAFE (available from NOF Corporation).

The N-vinyl compounds that can be used in the radiation-curable ink composition are compounds having a structure in which a vinyl group is bonded to nitrogen (>N—CH═CH₂). The N-vinyl compounds have radical polymerizability. Specific examples of the N-vinyl compounds that can be used in the radiation-curable ink composition include N-vinylformamide, N-vinylcarbazole, N-vinylindole, N-vinylpyrrole, N-vinylacetamide, N-vinylpyrrolidone, N-vinylcaprolactam, and derivatives thereof. Among these compounds, N-vinylformamide is particularly preferable. N-vinylformamide is available from, for example, Arakawa Chemical Industries Ltd.

The radiation-curable ink composition may contain a plurality of the polymerizable compounds exemplified above. The above polymerizable compounds have an unsaturated double bond and have a property of generating radicals. Accordingly, polymerizability or a color change property of the radiation-curable ink composition can be improved, and thus the polymerizable compounds can be suitably used in the radiation-curable ink composition. Among the exemplified polymerizable compounds, compounds having an active hydrogen-containing functional group readily generate radicals, and thus are further preferably used in order to improve polymerizability or the color change property of the radiation-curable ink composition. Examples of the active hydrogen-containing functional group include an amino group, an imino group, and an alcoholic hydroxyl group. Further preferably, the radiation-curable ink composition contains a polymerizable compound having any of these groups.

The content of the polymerizable compound in the radiation-curable ink composition is preferably in the range of 50 to 95 mass percent, more preferably in the range of 60 to 92 mass percent, and further preferably in the range of 70 to 90 mass percent relative to the total solid content of the composition.

The above polymerizable compounds have radical polymerizability. Accordingly, in the case where such a polymerizable compound is incorporated in the radiation-curable ink composition, a radical-generating species is present in the radiation-curable ink composition. In this case, when the radiation-curable ink composition is irradiated with radiation, radicals are generated in the radiation-curable ink composition. As described above, when a dye is irradiated with radiation and/or reacts with radicals, the color of the dye changes or degrades. Accordingly, when the radiation-curable ink composition contains the above polymerizable compound, the chance that the dye contacts radicals increases, and thus the percentage by which the color of the dye indirectly changes or degrades increases. Thus, by incorporating the polymerizable compound in the radiation-curable ink composition, the sensitivity to absorption of radiation can be increased.

When the polymerizable compound is radically polymerized, the radiation-curable ink composition is cured to form a cured product. The color of a dye changes or degrades depending on, for example, the amount of radicals generated by this polymerization. By adjusting the content of the dye or the polymerizable compound contained in the radiation-curable ink composition, the radiation-curable ink composition can be designed such that the color of a resulting cured product is also changed or degraded by irradiating the radiation-curable ink composition with radiation and/or by bringing the radiation-curable ink composition into contact with radicals. In such a case, the radiation-curable ink composition can be configured so that a significant change in the color can be observed even after curing, and thus the amount of radiation received by the cured product can be easily grasped.

### 1.6. Radiation-Sensitive Radical Polymerization Initiator

The radiation-curable ink composition may further contain a radiation-sensitive radical polymerization initiator. The radiation-sensitive radical polymerization initiator used in the radiation-curable ink composition can generate radicals when irradiated with radiation. Examples of the radiation that can generate radicals of the radiation-sensitive radical polymerization initiator include ultraviolet rays in the range of 400 to 200 nm, visible rays, far-ultraviolet rays, g-line, h-line, i-line, a KrF excimer laser beam, an ArF excimer laser beam, an electron beam, X-rays, molecular beams, and ion beams.

Examples of the radiation-sensitive radical polymerization initiator include aromatic ketones, aromatic onium salts, organic peroxides, hexaarylbiimidazoles, ketoxime esters, borates, azinium salts, metallocenes, active esters, and compounds having a carbon-halogen bond. More specifically, examples of ultraviolet ray polymerization initiator include benzyl dimethyl ketal, αhydroxyalkylphenones, α-aminoalkylphenones, acylphosphine oxides, oxime esters, thioxanthone, α-dicarbonyl, and anthraquinone.

Specific examples of the radiation-sensitive radical polymerization initiator that can be used in the radiation-curable ink composition include initiators available under the trade names of Vicure 10 and 30 (manufactured by Stauffer Chemical Company); Irgacure 127, 184, 500, 651, 2959, 907, 369, 379, 754, 1700, 1800, 1870, and 819, OXE01, Darocur 1173, TPO, and ITX (manufactured by Ciba Specialty Chemicals Inc.); Quantacure CTX (manufactured by Aceto Corporation); Kayacure DETX-S (manufactured by Nippon Kayaku Co., Ltd.); and ESACURE KIP150 (manufactured by Lamberti S.p.A).

The above radiation-sensitive radical polymerization initiators generate radicals when irradiated with radiation. For example, when a polymerizable compound is contained, the generated radicals can function as a polymerization initiator. Furthermore, the radicals can react with an oil-soluble dye or the like at the same time. Therefore, when the radiation-curable ink composition contains the radiation-sensitive radical polymerization initiator, the degree of a reaction between the oil-soluble dye or the like and the radicals increases, thereby increasing the percentage by which the color is indirectly changed or degraded by the radiation. Thus, by incorporating the radiation-sensitive radical polymerization initiator in the radiation-curable ink composition, the sensitivity to absorption of radiation can be increased. Furthermore, since the radiation-sensitive radical polymerization initiator generates radicals by irradiation of radiation, the rate of change in the color of the radiation-curable ink composition can be increased. Thus, the sensitivity of the radiation-curable ink composition to absorption of radiation can be further increased.

Even when a radiation that does not readily generate radicals is detected or when the amount of energy of a radiation received is small, by incorporating a radiation-sensitive radical polymerization initiator that can generate radicals by the radiation in the radiation-curable ink composition, the sensitivity of the radiation-curable ink composition to absorption of the radiation can be further increased.

### 1.7. Polymerization Accelerator

The radiation-curable ink composition may further contain a polymerization accelerator or the like. Examples of the polymerization accelerator that can be used in the radiation-curable ink composition include, but are not particularly limited to, Darocur EHA and EDB (available from Ciba Specialty Chemicals Inc.).

### 1.8. Thermal Radical Polymerization Inhibitor

The radiation-curable ink composition may further contain a thermal radical polymerization inhibitor. The incorporation of the thermal radical polymerization inhibitor can improve storage stability of the radiation-curable ink composition. Since the thermal radical polymerization inhibitor has a function of capturing and eliminating radicals, it may be optionally added in order to adjust, for example, the rate of a change in the color of the radiation-curable ink composition. An example of the thermal radical polymerization inhibitor is Irgastab UV-10 (available from Ciba Specialty Chemicals Inc.).

### 1.9. Surfactant

The radiation-curable ink composition may contain a surfactant in order to improve the storage stability or the like. For example, a polyester-modified silicone or a polyether-modified silicone can be used as a silicone surfactant. In particular, a polyether-modified polydimethylsiloxane or a polyester-modified polydimethylsiloxane can be used. Specific examples thereof include BYK-347, BYK-348, and BYK-UV3500, -UV3510, -UV3530 and -UV3570 (available from of BYK Japan K.K.).

### 1.10. Other Components

As other components, known wetting agents, penetrants, pH adjusters, preservatives, fungicides, and the like may be added to the radiation-curable ink composition. Furthermore, leveling additives, matte agents, and polyester resins, polyurethane resins, vinyl resins, acrylic resins, rubber resins, and waxes for adjusting physical properties of a recorded matter may be added according to need.

### 2. Recording Method

A recording method according to the invention is a method of recording information using the radiation-curable ink composition described in the section of “1. Radiation-curable ink composition”. The recording method of the invention is a method of recording information such as characters or images on a recording medium (such as paper, a film, or a cloth) using the radiation-curable ink composition. The recording method of the invention includes an ink jet recording method, recording methods such as offset printing and relief printing, and recording methods such as drawing and painting using a brush or the like. In embodiments below, a description will be made of methods of recording information by the ink jet recording method using the radiation-curable ink composition.

### 2.1. First Embodiment

A recording method according to a first embodiment is a method of recording information on a recording medium using an ink jet recording apparatus, the method including ejecting droplets of the above-described radiation-curable ink composition to cause the droplets of the radiation-curable ink composition to adhere to the recording medium. The ink jet recording apparatus that can be used in this embodiment is not particularly limited as long as recording can be conducted by causing the droplets to adhere to the recording medium.

Examples of a specific recording method employed by the ink jet recording apparatus include a method in which a strong electric field is applied between a nozzle and an accelerating electrode placed in front of the nozzle to successively eject an ink from the nozzle in the form of droplets, and a printing information signal is supplied to deflection electrodes while the ink droplets travels between the deflection electrodes to conduct recording, and the method in which the ink droplets are ejected so as to correspond to the printing information signal without deflecting the ink droplets (electrostatic attraction method); a method in which ink droplets are forcibly ejected by applying a pressure to a liquid ink using a small pump and mechanically vibrating a nozzle using a quartz oscillator or the like; a method in which a pressure and a printing information signal are simultaneously applied to a liquid ink using a piezoelectric element to eject and record the ink droplets (piezo method); and a method in which a liquid ink is foamed by heating using a microelectrode in accordance with a printing information signal to eject and record the ink droplets (thermal jet method).

An example of the ink jet recording apparatus used in this embodiment include an ink jet recording head, a body, a tray, a head driving mechanism, a carriage, an ultraviolet irradiation device provided on a side face of the carriage, and the like. For example, the ink jet recording head may include ink cartridges for ink jet recording of four colors, namely, cyan, magenta, yellow, and black so as to perform full-color printing. At least one of these cartridges for ink jet recording is filled with the above-described radiation-curable ink composition and placed in the recording head. This ink jet recording apparatus further includes a special control board or the like therein to control the ejection timing of the ink in the ink jet recording head and scanning of the head driving mechanism.

A plurality of cartridges for ink jet recording are provided, and at least one of these cartridges can be filled with the above-described radiation-curable ink composition. The other cartridges for ink jet recording may be filled with normal inks.

By using such an ink jet recording apparatus, the radiation-curable ink composition can be easily ejected and caused to adhere on a recording medium. Thus, information can be recorded.

The ultraviolet irradiation device for irradiating provided ultraviolet rays may be provided on a side face of the carriage in the ink jet recording apparatus. With the ultraviolet irradiation device, ultraviolet irradiation can be conducted by guiding light emitted from, for example, a metal halide lamp, a xenon lamp, a carbon arc lamp, a chemical lamp, a low-pressure mercury lamp, or a high-pressure mercury lamp using a light guide or the like to a coated film. The ultraviolet irradiation can be conducted using a commercially available lamp such as an H lamp, a D lamp, or a V lamp available from Fusion System etc. as the light source. Alternatively, as the light source, an ultraviolet light-emitting semiconductor device such as an ultraviolet light-emitting diode (ultraviolet LED) or an ultraviolet light-emitting semiconductor laser can be used. A recording medium or droplets adhered thereto can be irradiated with ultraviolet rays emitted from such a light source in the ink jet recording apparatus.

According to the ink jet recording apparatus including such an ultraviolet irradiation device, maintenance of the ultraviolet irradiation device can be performed easily and safely. An inspection of an ultraviolet irradiation device provided in an ink jet recoding apparatus has been performed while opening a casing of the ink jet recoding apparatus by an operator. During the inspection, the operator wears safety goggles or the like, but a portion such as unprotected skin may be irradiated with ultraviolet rays. The ink jet recording apparatus used in this embodiment forms a recorded matter using the above-described radiation-curable ink composition. Accordingly, the state of the ultraviolet irradiation device can be inspected by checking the color of the recorded matter formed by operating the ultraviolet irradiation device. Furthermore, in the above ink jet recording apparatus including an ultraviolet irradiation device, an inspection of a change with time (i.e., pot life) of the radiation-curable ink composition can be easily performed. For example, a recorded matter is formed using the above ink jet recoding apparatus so as to have a portion that has been irradiated with ultraviolet rays and a portion that has not been irradiated with ultraviolet rays. The sensitivity of the radiation-curable ink composition to radiation can be easily inspected by comparing the colors of these portions.

### 2.2. Second Embodiment

A recording method according to a second embodiment is a method of recording information on a recording medium using an ink jet recording apparatus, the method including mixing a first composition with a second composition in the ink jet recording apparatus to prepare the radiation-curable ink composition described in the section of “1. Radiation-curable ink composition”, and ejecting droplets of the radiation-curable ink composition to cause the droplets of the radiation-curable ink composition to adhere to the recording medium.

The ink jet recording apparatus used in the second embodiment includes a two-liquid mixing unit configured to mix two types of liquid. The structure of the two-liquid mixing unit is not particularly limited as long as two types of ink can be completely mixed. An example of the two-liquid mixing unit includes a pump section including a first actuator for supplying a first liquid and a second actuator for supplying a second liquid; and a mixer section including a first mixing chamber, branched chambers, and a second mixing chamber. In the first mixing chamber, the first liquid and the second liquid supplied from the pump section are combined and mixed. The resulting liquid mixed in the first mixing chamber is separated into a plurality of portions to pass through the branched chambers during which the pressure of each of the liquid portions supplied from the pump section is separately determined. In the second mixing chamber, the mixed liquids passed through the branched chambers are combined and further mixed. In this two-liquid mixing unit, a supply efficiency of each actuator can be changed by varying the frequency of a driving signal applied to the first and second actuators constituting the pump section. Thereby, the mixing ratio of the two liquids supplied to the unit can be arbitrarily adjusted.

In the second embodiment, by using an ink jet recording apparatus including the two-liquid mixing unit described above, a first composition and a second composition are mixed in the two-liquid mixing unit to prepare the above-described radiation-curable ink composition, and the radiation-curable ink composition is ejected and caused to adhere to a recording medium, thereby recording information. Other structures are the same as the ink jet recording apparatus described in the first embodiment.

The first composition and the second composition can be formed into the above-described radiation-curable ink composition by being mixed with each other. As for the compositions of the first composition and the second composition, the first composition contains a dye and the second composition contains a pigment. Any other components may be contained as long as a desired radiation-curable ink composition can be obtained.

The first composition contains a dye, and the second composition contains a pigment. In such a case, the color of the dye can be checked before the first composition is mixed with the second composition. In the case where radical-generating species such as a polymerizable compound and a radiation-sensitive radical polymerization initiator are incorporated in the radiation-curable ink composition, the radical-generating species are preferably added the second composition. In this case, the radical-generating species and the dye can be separately stored in the ink jet recording apparatus, and thus a color change or discoloration of the dye can be suppressed. Accordingly, the storage stability of the first composition can be improved, and as a result, the pot life of the radiation-curable ink composition can be improved.

### 2.3. Third Embodiment

A recording method according to a third embodiment is a method of recording information on a recording medium using an ink jet recording apparatus, the method including ejecting droplets of a first composition to cause the droplets of the first composition to adhere to the recording medium, ejecting droplets of a second composition to cause the droplets of the second composition to adhere to the recording medium, and mixing the first composition with the second composition on the recording medium to prepare the above-described radiation-curable ink composition.

An example of the ink jet recording apparatus used in this embodiment is the ink jet recording apparatus described in the first embodiment. In the ink jet recording apparatus, among a plurality of cartridges for ink jet recording, two cartridges are filled with the first composition and the second composition described in the second embodiment. Droplets of the first composition and droplets of the second composition are ejected from different nozzles to cause the droplets to adhere to a recording medium. In this step, the ink jet recording apparatus is controlled such that the first composition and the second composition are caused to adhere to at least one specific position on the recording medium. At the position at which both the first composition and the second composition are disposed, the first composition and the second composition are contacted and mixed to form a radiation-curable ink composition.

The order of adhesion of the droplets of the first composition and the second composition is arbitrary. However, from the standpoint that the droplets are readily arranged so that a pigment is covered with a dye when viewed from the upper surface of the recording medium, preferably, a step of adhesion of the second component is previously performed. When an ink jet recording apparatus including an ultraviolet irradiation device is used, the timing of irradiation of ultraviolet rays is arbitrary. However, in order to effectively mix the first composition with the second composition, the irradiation is preferably performed after the droplets of the first and second compositions are contacted and mixed.

Among the recording methods of the invention, examples of the methods using an ink jet recording apparatus have been described in the above three embodiments. The recording methods using an ink jet recording apparatus according to the above embodiments can be preferably applied to, besides the recording of information on the above-described recording medium, for example, recording of information on a non-absorptive recording medium such as a metal, glass, or a plastic; preparation of a color filter; and marking on a printed circuit board.

### 3. Recorded Matter

The invention provides a recorded matter on which information is recorded by the above recording method. The recording medium is not particularly limited. Examples of the recording medium include absorptive recording media such as paper, films, and cloths; and non-absorptive recording media such as metals, glass, and plastics. The recording medium may be colorless and transparent, translucent, colored and transparent, chromatic-colored and opaque, achromatic-colored and opaque, or the like. The recorded matter may be or may not be irradiated with ultraviolet rays during recording. The reason for this is that, even in a recorded matter that has been irradiated with ultraviolet rays during recording, the color of the recorded matter may be further changed by irradiating the recorded matter with radiation after recording. Since the recorded matter is formed using the radiation-curable ink composition, the color of the recorded matter changes in accordance with at least one of the amount of radiation absorbed by the recorded matter and the amount of radicals generated in the recorded matter. According the recorded matter of the invention, the amount of absorbed radiation and the amount of radicals generated in the recorded matter can be easily known.

### 4. Ink Set

An ink set according to the invention is a set of compositions including the radiation-curable ink composition described in the section of “1. Radiation-curable ink composition” and/or a set of the first composition and the second composition described in the section of “2. Recording method”. Examples of other compositions that can be included in the ink set include known ink compositions. Specific examples thereof include color ink compositions such as cyan, magenta, yellow, light cyan, light magenta, dark yellow, red, green, blue, orange, and violet; colorless clear ink compositions; light color clear ink compositions; black ink compositions; light black ink compositions; metal pigment ink compositions; and white pigment ink compositions.

### 5. Ink Cartridge for Ink Jet Recording

An ink cartridge for ink jet recording according to the invention can include the ink set described in the section of “4. Ink set”. According to the ink cartridge for ink jet recording, an ink set used in any of the above-described recording methods using an ink jet recording apparatus can be easily carried.

### 6. Radiation Detection Method

A radiation detection method according to the invention is a method of detecting the amount of radiation exposure by a change in the color of the radiation-curable ink composition or the recorded matter using the radiation-curable ink composition described in the section of “1. Radiation-curable ink composition” or the recorded matter described in the section of “3. Recorded matter”.

The radiation detection method is performed by utilizing the fact that the color of the radiation-curable ink composition or the recorded matter changes in accordance with the amount of dosage of radiation (the amount of radiation exposure). The change in the color can be detected using, for example, a color scale (color bar) by comparing the color of the radiation-curable ink composition or the recorded matter with the color scale (color bar). Alternatively, the change in the color can be detected by quantifying colors using a known calorimeter or the like, and comparing a value after irradiation with a value before irradiation. The detection of a change in the color can also be performed by using, for example, a calibration curve prepared in advance.

According to the radiation detection method, the amount of radiation received by a radiation-curable ink composition or a recorded matter can be simply and easily detected. Furthermore, according to the radiation-curable ink composition and the recorded matter used in the radiation detection method, energy for detecting radiation need not be supplied from the outside. Accordingly, the radiation-curable ink composition and the recorded matter can be used for a wide range of applications.

### 7. Management Method

A management method of the invention is a method of managing an object, the method including attaching the above-described recorded matter to the object, and measuring the amount of radiation or history of radiation irradiated onto the object by a change in the color of the recorded matter to manage the change in the object with time.

A management method of the invention is a method of managing an object, the method including attaching the above-described radiation-curable ink composition to the object, and measuring the amount of radiation or history of radiation irradiated onto the object by a change in the color of the radiation-curable ink composition to manage the change in the object with time.

Examples of objects that can be managed by the management method of the invention include industrial products, foods, drugs, clothes, and living bodies. Examples of the objects further include products or semi-manufactured products during a production step of industrial production. For example, in industrial products and foods, managing an object means to grasp the amount of radiation received during exposure, storage, or transportation in a distribution process to manage the industrial products and foods. For example, in clothes and living bodies, managing an object means to grasp the amount of irradiated radiation to manage the clothes and living bodies. Furthermore, when a production process includes a step of irradiating an object with radiation, managing products and semi-manufactured products means to grasp whether the step has been performed or not, whether a desired amount of radiation has been exposed or not in the step, or the like to manage the production process. Thus, the management method of the invention is a method of managing an object by determining whether the object has been changed or not by radiation received during a specific term (i.e., managing a change with time).

The radiation-curable ink composition or the recorded matter used in the management method of the invention is the radiation-curable ink composition described in the section of “1. Radiation-curable ink composition” or the recorded matter described in the section of “3. Recorded matter”. As for the method of attaching the radiation-curable ink composition or the recorded matter to an object, the radiation-curable ink composition may be attached by causing the radiation-curable ink composition to directly adhere to the object. Alternatively, a recorded matter formed by causing the radiation-curable ink composition to adhere to a recording medium such as paper or a film may be attached to the object by an appropriate method. Furthermore, as for the method of attaching the radiation-curable ink composition to an object, a container containing the radiation-curable ink composition may be attached to the object. Such a container is not particularly limited as long as target radiation can transmit through the container.

According the management method of the invention, the amount of radiation or history of radiation (the amount of integrated radiation) irradiated onto an object can be easily grasped by a change in the color of the radiation-curable ink composition or the recorded matter. Accordingly, a change in the object with time can be easily managed.

### 8. Examples and Comparative Examples

The invention will be further specifically described below with reference to Examples and Comparative Examples, but the invention is not limited to the Examples below. Specific examples of nonaqueous radiation-curable ink compositions containing an oil-soluble dye as a dye will be described in Examples below.

### 8.1. Oil-Soluble Dye

Two types of oil-soluble dyes, namely, ORACET RED BG and ORACET YELLOW 3GN (both of which were manufactured by Ciba Specialty Chemicals Inc.) were prepared. The color of ORACET RED BG belongs to “5R” among the ten hues of the Munsell color system, and the color of ORACET YELLOW 3GN belongs to “5Y” among the ten hues of the Munsell color system.

### 8.2. Pigment

As pigments, Pigment Blue 15:3 and Pigment Green-7 were prepared. Pigment Blue 15:3 belongs to “10B” among the ten hues of the Munsell color system, and Pigment Green-7 belongs to “5BG” among the ten hues of the Munsell color system.

### 8.3. Dispersant

In order to further improve dispersibility of the pigments, Discole N-518 (manufactured by Dai-Ichi Kogyo Seiyaku Co., Ltd.), which is a polyoxyalkylene polyalkylene polyamine, was prepared as a dispersant.

### 8.4. Polymerizable Compound

As polymerizable compounds, N-vinylformamide (trade name: Beamset 770; manufactured by Arakawa Chemical Industries Ltd.), ethylene glycol monoallyl ether (manufactured by Nippon Nyukazai Co., Ltd.), tripropylene glycol diacrylate, and ethoxylated glycerin triacrylate A-Gly-3E (manufactured by Shin-Nakamura Chemical Co., Ltd.) were prepared.

### 8.5. Radiation-Sensitive Radical Polymerization Initiator

As radiation-sensitive radical polymerization initiators, Irgacure 819 and Irgacure 369 (both of which were manufactured by Ciba Specialty Chemicals Inc.) were prepared.

### 8.6. Surfactant

As a surfactant, BYK-UV3570 (manufactured by BYK Japan K.K.) was prepared.

### 8.7. Preparation of Ink Composition

The above oil-soluble dyes, the pigments, the dispersant, the polymerizable compounds, the radiation-sensitive radical polymerization initiators, and the surfactant were mixed by a procedure described below so that the resulting mixtures had the final compositions (mass percent) shown in Table 1. Thus, radiation-curable nonaqueous ink compositions of Example 1 to Example 3 and ink compositions of Comparative Example 1 to Comparative Example 3 were prepared. In each of Example 1 and Example 2, a hue of the color of an oil-soluble dye contained in the radiation-curable nonaqueous ink composition and a hue of the color of a pigment are not adjacent to each other in the ten hues of the Munsell color system. In Example 3, the color of an oil-soluble dye contained in the radiation-curable nonaqueous ink composition and the color of the pigment satisfy a complementary color relationship in the hue circle of the Munsell color system. Comparative Example is an example of an ink composition that contains neither an oil-soluble dye nor a pigment, and Comparative Examples 2 and 3 are examples of ink compositions that contain either an oil-soluble dye or a pigment.

TABLE 1

| | | Examples | | | Comparative Examples | | |
|---|---|---|---|---|---|---|---|
| | (mass %) | 1 | 2 | 3 | 1 | 2 | 3 |
| Oil-Soluble Dye | ORACET RED BG | 1.0 | 0.5 | 1.0 | — | — | 1.0 |
| | ORACET YELLOW | — | 0.5 | 1.0 | — | — | — |
| | 3GN | | | | | | |
| Pigment | Pigment Blue 15:3 | 3.0 | 3.0 | — | — | 3.0 | — |
| | Pigment Green 7 | — | — | 3.0 | — | — | — |
| Dispersant | Discole N-518 | 1.0 | 1.0 | 1.0 | 1.0 | 1.0 | 1.0 |
| Polymerizable | N-vinylformamide | 25.0 | 25.0 | 25.0 | 25.0 | 25.0 | 25.0 |
| compound | Ethylene glycol | 29.8 | 29.8 | 29.8 | 34.8 | 30.8 | 33.8 |
| | monoallyl ether | | | | | | |
| | Tripropylene glycol | 20.0 | 20.0 | 20.0 | 20.0 | 20.0 | 20.0 |
| | diacrylate | | | | | | |
| | A-Gly-3E | 15.0 | 15.0 | 15.0 | 15.0 | 15.0 | 15.0 |
| Radiation- | Irgacure 819 | 4.0 | 4.0 | 4.0 | 4.0 | 4.0 | 4.0 |
| sensitive radical | Irgacure 369 | 1.0 | 1.0 | 1.0 | 1.0 | 1.0 | 1.0 |
| polymerization | | | | | | | |
| initiator | | | | | | | |
| Surfactant | BYK-UV3570 | 0.2 | 0.2 | 0.2 | 0.2 | 0.2 | 0.2 |
| Results | Initial color of | Purple | Reddish | Black | Colorless and | Blue | Red |
| | composition | | black | | transparent | | |
| | Color of composition | Blue | Blue | Green | Colorless and | Blue | Light yellow |
| | after radiation | | | | transparent | | and |
| | irradiation | | | | | | transparent |

The radiation-curable nonaqueous ink composition of Example 1 was prepared as follows. First, Pigment Blue 15:3 used as a pigment, Discole N-518 used as a dispersant, and ethylene glycol monoallyl ether (hereinafter, also referred to as AG) used as a polymerizable compound were mixed under stirring so that the mixing ratio was 15:5:80 (parts by mass). The resulting mixture was dispersed together with zirconia beads (with a diameter of 1.5 mm) for six hours using a sand mill (manufactured by Yasukawa Seisakusho K.K.). Next, the zirconia beads were removed with a separator to prepare a pigment dispersion liquid.

On the other hand, the polymerizable compounds other than AG, the radiation-sensitive radical polymerization initiators, and the surfactant, all of which are shown in Table 1, were mixed and the resulting mixture was stirred until the mixture became homogeneous. Next the oil-soluble dye was added to the mixture, and the resulting mixture was stirred until the mixture became homogeneous to prepare a dye mixture.

The pigment dispersion liquid prepared above was mixed with the dye mixture by gradually adding the pigment dispersion liquid dropwise while stirring the dye mixture so that the resulting mixture had the final composition shown in Table 1. After the target composition was obtained, the mixture was further stirred for 30 minutes at normal temperature. Subsequently, the mixture was filtered through a membrane filter with a pore diameter of 5 μm. Thus, the radiation-curable nonaqueous ink composition of Example 1 was prepared. The radiation-curable nonaqueous ink composition of Examples 2 and 3, and the ink compositions of Comparative Examples 1 to 3 were also similarly prepared.

### 8.8. Evaluation Test

For each of the Examples and the Comparative Examples, the following test was performed. An ink jet printer PM-G920 manufactured by Seiko Epson Corporation was prepared. The ink composition prepared above was filled so as to be ejected from a nozzle row corresponding to a photo black ink of this printer. Character printing was then performed at normal temperature and normal pressure. An OHP film (A4 size, manufactured by Fuji Xerox Co., Ltd., XEROX-FILM <non-frame>) was used as a recording medium. The maximum film thickness of a film formed by the character printing was 10 μm. In this state, the recorded color was checked and described in Table 1 as an initial color of the composition.

Subsequently, the film formed by the character printing was irradiated with ultraviolet rays using an ultraviolet irradiation light source with a light intensity of 120 mW/cm² such that the integrated light intensity was 3,000 J/cm². In this state, the recorded color was checked and described in Table 1 as a color of each Example or Comparative Example after radiation irradiation.

### 8.9. Evaluation Results

As shown in Table 1, the color of each of the radiation-curable nonaqueous ink composition of Examples 1 to 3 was changed by the irradiation of radiation (ultraviolet rays). In contrast, the color of each ink composition of Comparative Example 1 and Comparative Example 2 was not changed by the irradiation of ultraviolet rays. The color of the ink composition of Comparative Example 3 almost disappeared by the irradiation of ultraviolet rays.

These results showed that the color of each of the radiation-curable nonaqueous ink composition of Examples was significantly changed by irradiation of radiation.

Furthermore, in Example 3, the color of the oil-soluble dye and the color of the pigment satisfy a complementary color relationship in the hue circle of the Munsell color system. Accordingly, the initial color was black and the color after the radiation irradiation was green. Thus, the color was more significantly changed.

It was found that, in all Examples, a satisfactory coating film of an ink composition was formed on the recording medium after the irradiation of ultraviolet rays.

The invention is not limited to the above-described embodiments, and various modifications can be further made. For example, the invention includes configurations substantially the same as the configurations described in the embodiments (e.g., configurations in which functions, methods, and results are the same, and configurations in which objects and advantages are the same). Furthermore, the invention includes configurations in which a nonessential portion of the configurations described in the embodiments is replaced. The invention further includes configurations in which operations and advantages that are the same as those of the configurations described in the embodiments are achieved, and configurations which achieve the same objects as those of the configurations described in the embodiments. Furthermore, the invention includes configurations in which the related art is added to the configurations described in the embodiments.

What is claimed is:

1. A radiation-curable ink composition comprising:
a dye; and
a pigment having a color of a hue that is not adjacent to a hue of the color of the dye in ten hues of the Munsell color system.

2. The radiation-curable ink composition according to claim 1, wherein the color of the pigment and the color of the dye satisfy a complementary color relationship.

3. The radiation-curable ink composition according to claim 1, further comprising:
a polymerizable compound.

4. The radiation-curable ink composition according to claim 3, wherein the polymerizable compound has an unsaturated double bond.

5. The radiation-curable ink composition according to claim 3, wherein the polymerizable compound has an active hydrogen-containing functional group.

6. The radiation-curable ink composition according to claim 5, wherein the active hydrogen-containing functional group is an amino group, an imino group, or an alcoholic hydroxyl group.

7. The radiation-curable ink composition according to claim 1, further comprising:
a radiation-sensitive radical polymerization initiator.

8. An ink set comprising:
the radiation-curable ink composition according to claim 1.

9. A recording method comprising:
recording information using the radiation-curable ink composition according to claim 1.

10. A method of recording information on a recording medium using an ink jet recording apparatus, comprising:
ejecting droplets of the radiation-curable ink composition according to claim 1 to cause the droplets of the radiation-curable ink composition to adhere to the recording medium.

11. A method of recording information on a recording medium using an ink jet recording apparatus, comprising:
mixing a first composition containing a dye with a second composition containing a pigment in the ink jet recording apparatus to prepare the radiation-curable ink composition according to claim 1; and
ejecting droplets of the radiation-curable ink composition to cause the droplets of the radiation-curable ink composition to adhere to the recording medium.

12. A method of recording information on a recording medium using an ink jet recording apparatus, comprising:
ejecting droplets of a first composition containing a dye to cause the droplets of the first composition to adhere to the recording medium;
ejecting droplets of a second composition containing a pigment to cause the droplets of the second composition to adhere to the recording medium; and
mixing the first composition with the second composition on the recording medium to prepare the radiation-curable ink composition according to claim 1.

13. The method according to claim 12, wherein the droplets of the second composition are caused to adhere to the recording medium first, and the droplets of the first composition are then caused to adhere to the recording medium.

14. The method according to claim 10, further comprising:
irradiating the droplets adhered to the recording medium with radiation.

15. A recorded matter recorded by the method according to claim 9.

16. An ink set comprising:
the first composition and the second composition according to claim 11.

17. An ink cartridge for ink jet recording comprising:
the ink set according to claim 8.

18. An ink jet recording apparatus comprising:
the ink cartridge for ink jet recording according to claim 17.

19. The ink jet recording apparatus according to claim 18, further comprising:
an ultraviolet irradiation device.

20. A radiation detection method comprising:
detecting the amount of radiation exposure using the recorded matter according to claim 15 by a change in the color of the radiation-curable ink composition according to claim 1.

21. A radiation detection method comprising:
detecting the amount of radiation exposure using the radiation-curable ink composition according to claim 1 by a change in the color of the radiation-curable ink composition.

22. A method of managing an object using the radiation detection method according to claim 20, comprising:
attaching the recorded matter to the object; and
measuring the amount of radiation or history of radiation irradiated onto the object by a change in the color of the recorded matter to manage the change in the object with time.

23. A method of managing an object using the radiation detection method according to claim 21, comprising:
attaching the radiation-curable ink composition to the object; and
measuring the amount of radiation or history of radiation irradiated onto the object by a change in the color of the radiation-curable ink composition to manage the change in the object with time.

24. The method according to claim 23, wherein, in attaching the radiation-curable ink composition, a container containing the radiation-curable ink composition is attached to the object.
